(19) United States
(12) Patent Application Publication
(10) Pub. No.: US 2021/0252633 A1
(43) Pub. Date: Aug. 19, 2021

(54) LASER PROCESSING SYSTEMS WITH MULTI-CAMERA VISION SUBSYSTEMS AND ASSOCIATED METHODS OF USE

(71) Applicant: Universal Laser Systems, Inc., Scottsdale, AZ (US)

(72) Inventors: Yefim P. Sukhman, Scottsdale, AZ (US); Tim Crews, Scottsdale, AZ (US); Austyn Bontrager, Scottsdale, AZ (US); Craig Beiferman, Scottsdale, AZ (US); David T. Richter, Scottsdale, AZ (US); Matt Ricketts, Scottsdale, AZ (US); Lucas Gilbert, Scottsdale, AZ (US); Christian J. Risser, Scottsdale, AZ (US)

(21) Appl. No.: 17/178,010

(22) Filed: Feb. 17, 2021

Related U.S. Application Data
(60) Provisional application No. 62/978,055, filed on Feb. 18, 2020.

(51) Int. Cl. B23K 26/03; B23K 26/082; B23K 26/36; B23K 26/12

(52) U.S. Cl. CPC B23K 26/032; B23K 26/127; B23K 26/36; B23K 26/082

(57) ABSTRACT

Laser processing systems that employ multi-camera vision subsystems and associated methods of use and manufacture are disclosed herein. In some embodiments, a method for processing one or more materials or compositions of materials with a laser processing system comprises generating, via a first camera carried by the laser processing system, a first preview image of one or more materials to be processed. The first preview image comprises an image of an entire material processing field. The method also comprises generating, via a second camera carried by the laser processing system, a second preview image. The second preview image comprises an image of only a selected portion of the material processing field from the first preview image. Based on the second preview image, the method further comprises modifying a design file relative to a material to be processed.

### CROSS-REFERENCE TO RELATED APPLICATION(S)

This application claims the benefit of U.S. Provisional Patent Application No. 62/978,055, filed Feb. 18, 2020, the disclosure of which is incorporated by reference herein in its entirety.

### TECHNICAL FIELD

The present disclosure is directed generally to laser processing systems and, more specifically, to laser processing systems that employ multi-camera vision subsystems and associated methods of use and manufacture.

### BACKGROUND

Laser processing systems are being adopted in manufacturing for material processing at an ever-increasing rate. Laser processing offers many advantages over more conventional processing techniques. For example, laser processing is particularly suited for cutting shapes or profiles out of materials, marking or preparing materials by removing or modifying surface layers of materials, and welding or sintering materials, because it offers the advantage of providing non-contact, tool-less, and fixture-less methods of processing materials. In many cases, laser processing is replacing processes that require investments in tooling such as dies for die cutting, masks for silk screening, or templates and fixtures for hard tooling.

### BRIEF DESCRIPTION OF THE DRAWINGS

FIG. 1A is a partially exploded isometric view of a laser material processing system including a multi-camera vision subsystem configured in accordance with embodiments of the present technology.

FIG. 1B an isometric view of the laser material processing system of FIG. 1A with the lid of the laser material processing system in an open configuration.

FIG. 1C is an enlarged view of a portion of the laser material processing system of FIG. 1B.

FIG. 2 is a flow diagram of a method for processing one or more materials or compositions of materials with a laser processing system.

FIGS. 3-5 are example graphical user interfaces for viewing the processing area in accordance with embodiments of the present technology.

### DETAILED DESCRIPTION

The following disclosure describes various embodiments of laser processing systems that employ multi-camera vision subsystems and associated methods of using and manufacturing such systems. In some embodiments, a laser material processing system includes a housing with a material support therein and a lid pivotably coupled to and movable relative to the housing. The system also comprises an optical carriage assembly configured to receive and modify a laser beam from a laser source and direct the laser beam toward a material to be processed carried by the material support. The system further comprises a display and a multi-camera vision subsystem operably coupled to a controller and the display. The multi-camera vision system comprises a first camera carried by the lid and configured to obtain first imaging data when the lid is in an open position, and a second camera movably carried by the optical carriage assembly and configured to provide second imaging data. The first imaging data from the first camera comprises imaging data from all or substantially all of a material processing field within the housing, while the second imaging data from the second camera comprises more precise imaging data from only a selected region of the material processing field that is less than the entire material processing field. The first and second imaging data can be displayed together and/or separately via the display.

In another embodiment of the present technology, a method for processing one or more materials or compositions of materials with a laser processing system comprises generating, via a first camera carried by the laser processing system, a first preview image of one or more materials to be processed. The first preview image comprises an image of an entire material processing field. The method further comprises generating, via a second camera carried by the laser processing system, a second preview image. The second preview image comprises an image of only a selected portion of the material processing field from the first preview image. Based on the second preview image, the method can further include modifying a design file relative to a material to be processed.

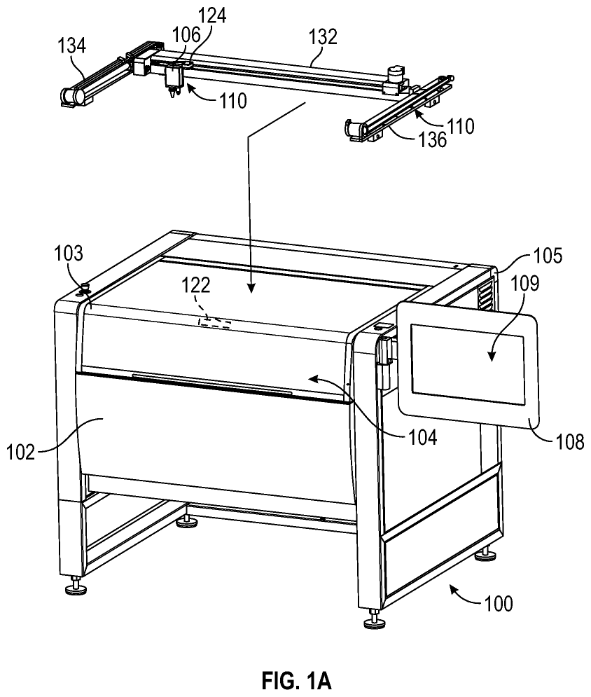

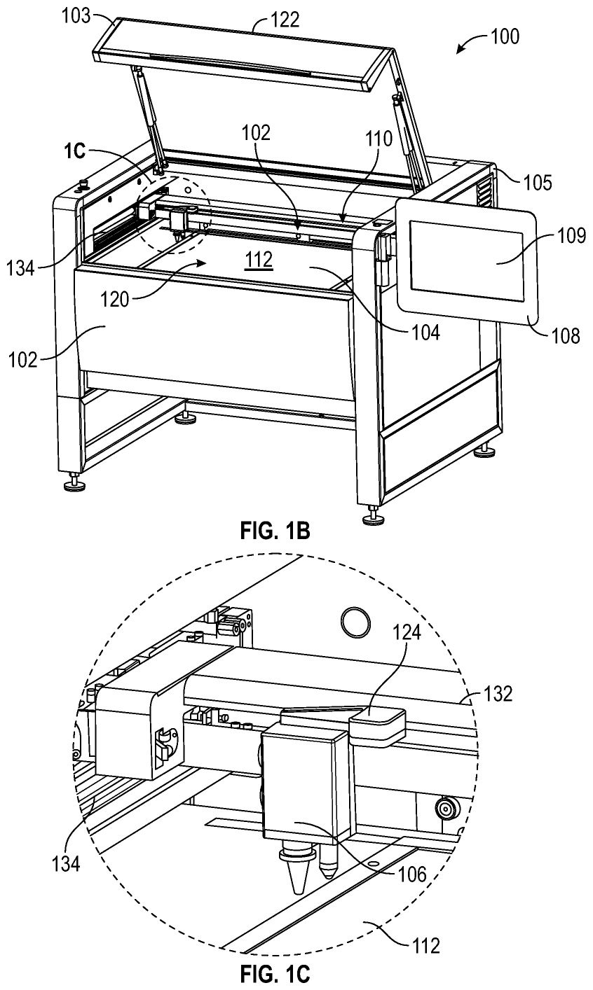

Certain details are set forth in the following description and in FIGS. 1A-5 to provide a thorough understanding of various embodiments of the disclosure. Other details describing well-known structures and systems often associated with laser processing systems and methods for forming and using such systems, are not set forth in the following disclosure to avoid unnecessarily obscuring the description of the various embodiments of the disclosure.

Depending upon the context in which it is used, the term “optical element” can refer to any of a variety of structures that can direct, transmit, steer, shape, or otherwise modify or influence laser radiation. In general, the term “optical element” can refer to different structures that provide generally similar functions. In addition, optical elements can have any of a variety of shapes or configurations depending on cost, efficiency, or other parameters of an optical system. For example, in some embodiments a conventional spherical lens can be replaced with a Fresnel lens (or vice-versa). Further, unless clearly indicated by the context, the use of a specific term in the disclosure to describe an optical element (e.g., a lens, mirror, etc.) does not limit the optical element to that particular structure or device. The term “optics” as used herein can refer to a discrete arrangement of optical elements that can optionally include electrical components, mechanical components, or other suitable components.

Many of the details, dimensions, angles, or other portions shown in the Figures are merely illustrative of particular embodiments of the technology and may be schematically illustrated. As such, the schematic illustration of the features shown in the Figures is not intended to limit any structural features or configurations of the processing systems disclosed herein. Accordingly, other embodiments can have other details, dimensions, angles, or portions without departing from the spirit or scope of the present disclosure. In addition, further embodiments of the disclosure may be practiced without several of the details described below, while still other embodiments of the disclosure may be practiced with additional details or portions.

### Embodiments of Laser Material Processing Systems and Associated Methods

FIG. 1A is a partially exploded isometric view of a laser material processing system 100 (“processing system 100”) configured to process materials and/or compositions in accordance with embodiments of the present technology, and FIG. 1B an isometric view of the laser material processing system 100 of FIG. 1A with a lid of the laser processing system in an open configuration Referring to FIGS. 1A and 1B together, the processing system 100 includes a housing 102 with a laser material processing region or processing chamber 104 therein. The processing chamber 104 contains a laser beam delivery subsystem 110 (“beam delivery subsystem 110”) configured to deliver a laser beam from laser source 105 to material (not shown) to be laser processed within a material processing field of the processing chamber 104. The beam delivery subsystem 110 includes an optical carriage assembly 106 moveably coupled to guide member(s) and positioned over a surface of a work plane or material support 112. For purposes of illustration and clarity, in FIG. 1A the beam delivery subsystem 110 and optical carriage assembly 106 are shown in an exploded arrangement spaced apart from the housing 102. A lid 103 is pivotably coupled to the housing 102 and is configured to be movable between (a) a first or open position to allow a user access to the processing chamber 104 (FIG. 1B) and (b) a second or closed position for laser processing operations (FIG. 1A).

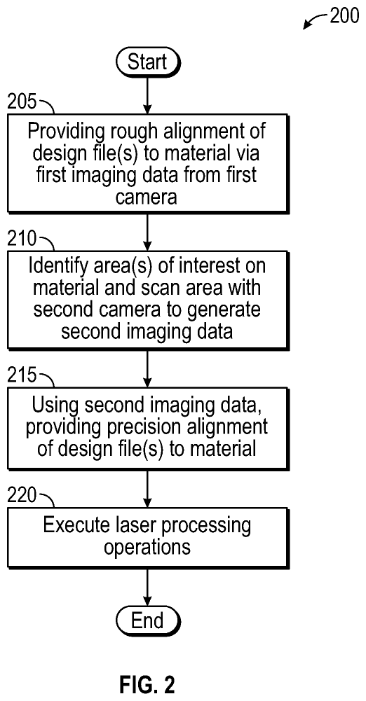

FIG. 1C is an enlarged view of a portion of the processing system 100 of FIG. 1B when with the lid 103 in an open position. Referring to FIGS. 1A-1C together, the processing system 100 further includes a multi-camera vision subsystem 120 including dual cameras—a first camera 122 carried by the lid 103 and a second camera 124 carried by the optical carriage assembly 106. The first camera 122 is an overhead camera that is configured to remain in a fixed/static position and capture imaging data when the lid 103 is in an open position relative to the housing 102. The second camera 124 is a movable, scanning camera carried by the optical carriage assembly 106 and is configured to move throughout processing operations as the optical carriage assembly 106 moves relative to the workpiece (not shown). As described in greater detail below with reference to FIGS. 2-5, the multi-camera vision subsystem 120 is configured to allow both coarse/rough alignment and precise/fine alignment of design file(s) to workpieces prior to processing.

Referring again to FIGS. 1A-1C together, in operation, the carriage assembly 106 is movable along a first guide rail or guide member 132 (extending along an X-axis), a second guide rail/guide member 134 and third guide rail/guide member 136 (both extending along a Y-axis) along which the carriage assembly 106 may be positioned for processing. The X rail 132 includes a motor, and the two Y rails 134 and 136 each include a dedicated motor. The synchronized X rail motor and dual Y rail motors are expected to provide precision positioning of the optical carriage assembly 106 for increased accuracy and performance during laser processing. The optical carriage assembly 106 is configured to guide a laser beam toward the surface of the work plane 112. The beam delivery subsystem 110 can be configured to weld or sinter materials, cut shapes or profiles out of materials, and mark or prepare materials by removing or modifying surface layers of materials.

The processing system 100 can further include a controller 108 operably coupled to the one or more motors for moving the optical carriage assembly 106 and/or one or more of the guide rails/guide members. In operation, the controller 108 can cause the beam delivery subsystem 110 to move the laser beam in X- and Y-axis directions to process materials placed on the work plane 112. The controller 108 can include, for example, a special purpose computer or data processor specifically programmed, configured, or constructed to perform computer-executable instructions. Furthermore, the controller 108 can refer to any device capable of communicating with a network or other electronics having a data processor and other components, e.g., network communication circuitry.

The processing system 100 further includes a display 109 operably coupled to the controller 108 and configured to display an image or representation of the work plane 112 and material(s) being processed both before and during laser processing. The display 109 may use image data from the multi-camera vision subsystem 120, other available imaging sources, or combinations thereof. The image data may be presented as two-dimensional, three-dimensional, or four-dimensional (including e.g., time-based or velocity-based information) images and/or as images from design file(s) created before processing. In additional embodiments, the display 109 may be adapted to provide additional information/functionality to the user before, during, and/or after laser processing.

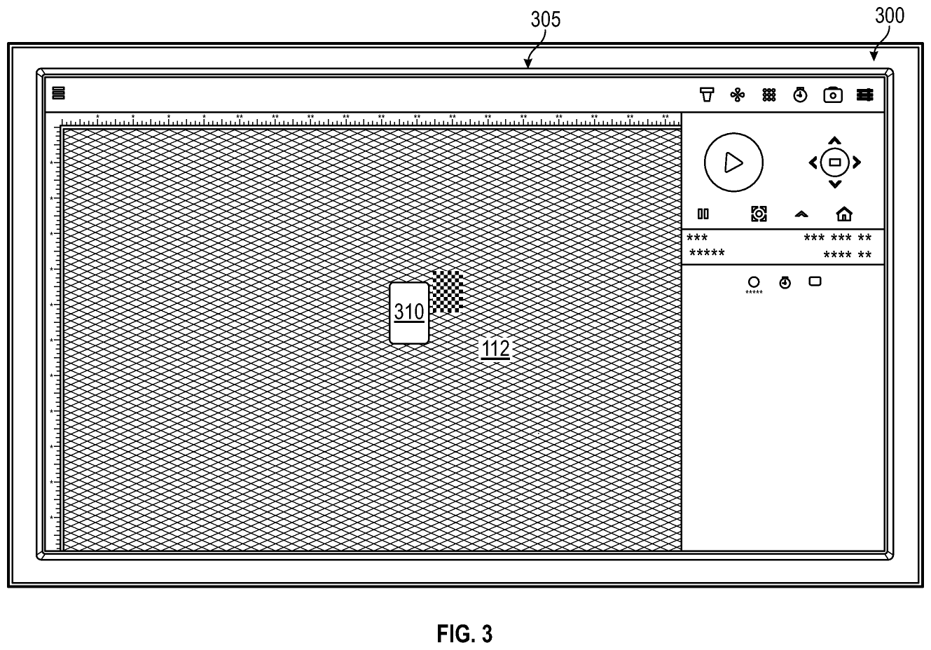

FIG. 2 illustrates an example method 200, implemented by the processing system 100 described above with reference to FIGS. 1A and 1B or another suitable system, for processing one or more materials or compositions of materials. FIGS. 3-5 illustrate example graphical user interfaces through which previews of various aspects of the laser processing operations may be displayed. The graphical user interfaces shown in FIGS. 3-5 may be displayed, for example, in the display 109 (FIG. 1A) or other suitable display systems. It will also be appreciated that the example graphical user interfaces illustrated in FIGS. 3-5 are merely examples of suitable interfaces for displaying such information, and the information may be displayed in a different fashion in other embodiments of the present technology.

Beginning at block 205 (and with reference to both FIG. 2 and FIG. 3), the method 200 includes providing a user with rough alignment information of design file(s) to material(s). As shown in FIG. 3, for example, graphical user interface 300 includes a preview 305 of a material processing field of the work plane 112 (FIG. 1) and one or more workpieces 310 (only one is shown here for purposes of illustration) arranged thereon. The view shown in FIG. 3 is based on first imaging data from the first camera 122 (FIG. 1A)—the fixed/static overhead camera of the multi-camera vision subsystem 120. The preview 305 also includes rough alignment information between design file(s) associated with each material to be processed. Based on this rough alignment information, the preview 305 provides a virtual representation of how the workpiece(s) 310 will appear when processing is complete. By way of example, workpiece 310 will be processed to include a checkerboard pattern thereon (as shown in preview 305 of FIG. 3 when the corresponding design file information has been aligned with/oriented (at least roughly) with an image of the workpiece 310. In some embodiments, preview 305 may further illustrate rough/preliminary alignment of design file information for one or more additional workpieces 310a-.

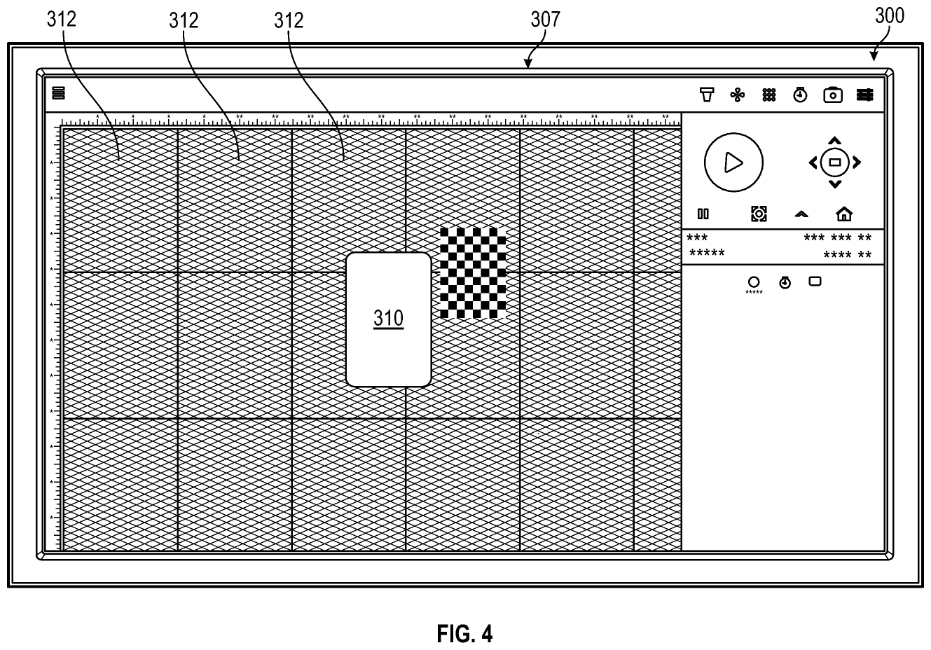

At block 210 (and with reference to both FIG. 2 and FIG. 4), one or more areas of interest may be identified from the preview 305. At block 215, the method 200 includes scanning such area(s) using the second camera 124 (FIG. 1B) of the multi-camera vision subsystem 120 to provide detailed, precise imaging data (i.e., second imaging data). As provided above, the second camera 124 is a movable, scanning camera carried by the optical carriage assembly 106 and configured to move throughout the work plane 112. The preview 307 shown in FIG. 4, for example, is based on detailed imaging information obtained by the second camera 124 after scanning regions near the center of the work plane 112 and workpiece 310. The preview 307 includes a series of detailed subviews 312 (obtained via the second camera 124) stitched or otherwise joined together to form preview 307. Like preview 305 described above with reference to FIG. 3, the preview 307 of FIG. 4 also provides a virtual representation of how the workpiece 310 will appear when processing is complete, but preview 307 presents this information only for an area of interest (a “zoomed in” view) of the work plane 112. This preview 307 allows a user to make precise, detailed alignment between the design file(s) and corresponding materials prior to processing as compared with trying to make such adjustments using only the first imaging data.

Obtaining detailed imaging data via the second camera 124 (block 210) can take a significant amount of time—the scanning operations are time intensive, particularly when obtaining such a significant amount of image data necessary to create the detailed, precise views show in FIG. 4. One particular feature of the method 200, however, is that because the preview 307 is only for a selected area of interest much smaller than the full work plane 112 (FIGS. 1A and 1B), the time necessary to obtain the detailed image data necessary to generate the preview 307 is much less than that required to scan the entire work plane 112. Accordingly, by limiting the scanning to the area of interest, it is expected to provide a significantly more efficient and timely process, while still providing detailed, precise imaging data.

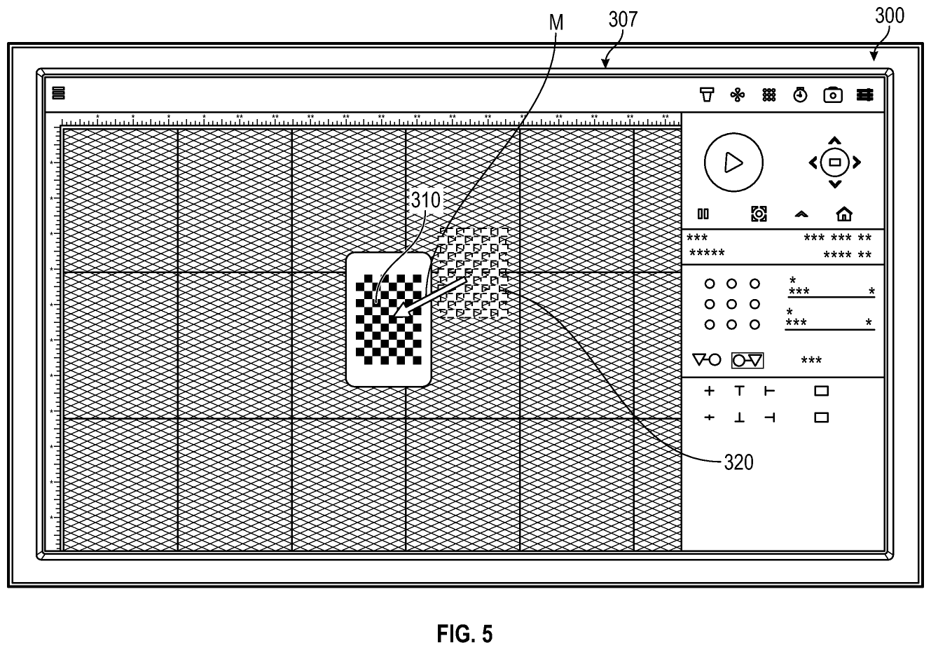

As an optional step, after reviewing the detailed information presented in preview 307, a user may further manipulate one or more design files relative to the corresponding material before processing. FIG. 5, for example, illustrates a user manipulating a design file 320 associated with the workpiece 310 to a more desirable orientation relative to the workpiece 310 (as shown by the arrow M). This alignment process allows a user to translate, rotate, scale, skew, or otherwise manipulate the design file 320 relative to the material prior to processing. The detailed preview 307 of FIGS. 4 and 5 (based on imaging data from the multi-camera vision subsystem 120) is expected to enable precise, fine alignment of design file(s) to material(s), thereby resulting in more efficient and effective laser processing operations.

Returning to FIG. 2, at block 220, once the user is satisfied with the alignment between the design file(s) and the corresponding materials, laser processing operations can be operations can be executed.

As discussed above, various aspects and implementations of the technology as described herein can be provided automatically or semi-automatically. Although this has been described in the general context of computer-executable instructions, such as routines executed by a general-purpose computer, e.g., a server or personal computer. Those of ordinary skill in the art will appreciate that aspects of the technology can be practiced with other computer system configurations, including Internet appliances, set-top boxes, hand-held devices, wearable computers, mobile phones, multiprocessor systems, microprocessor-based systems, minicomputers, mainframe computers, programmable logic controllers, or the like. Aspects of the technology can be embodied in a special purpose computer or data processor that is specifically programmed, configured, or constructed to perform one or more of the computer-executable instructions explained in detail below. Indeed, the terms “computer” or “controller” as used generally herein, refers to any of the above devices as well as any data processor or any device capable of communicating with a network, including consumer electronic goods such as gaming devices, cameras, or other electronics having a data processor and other components, e.g., network communication circuitry. Data processors include programmable general-purpose or special-purpose microprocessors, programmable controllers, application specific integrated circuits (ASICs), programmable logic devices (PLDs), or the like, or a combination of such devices. Software may be stored in memory, such as random-access memory (RAM), read-only memory (ROM), flash memory, or the like, or a combination of such components. Software may also be stored in one or more storage devices, such as magnetic or optical based disks, flash memory devices, or any other type of non-volatile storage medium or non-transitory medium for data. Software may include one or more program modules which include routines, programs, objects, components, data structures, and so on that perform particular tasks or implement particular abstract data types.

Aspects of the technology can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or subroutines may be located in both local and remote memory storage devices. Aspects of the technology described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those of ordinary skill in the art will recognize that portions of the technology may reside on a server computer, while corresponding portions reside on a client computer. Data structures and transmission of data particular to aspects of the invention are also encompassed within the scope of the technology.

### Conclusion

From the foregoing, it will be appreciated that specific embodiments of the disclosure have been described herein for purposes of illustration, but that various modifications may be made without deviating from the spirit and scope of the various embodiments of the disclosure. For example, although many of features of the system are described above with reference to singular components that are illustrated schematically in the Figures, in other embodiments the system can include multiple components. Similarly, while certain features are shown have multiple components, in other embodiments, the system can include more or fewer components than are illustrated. Moreover, because many of the basic structures and functions of laser processing systems are known, they have not been shown or described in further detail to avoid unnecessarily obscuring the described embodiments.

As used herein, the word “or,” unless expressly stated to the contrary, means any single item in a list of items, all of the items in the list, or any combination of the items in the list. The expression “an embodiment,” or similar formulations thereof, means that a particular feature or aspect described in connection with the embodiment can be included in at least one embodiment of the present technology. For ease of reference, identical reference numbers are used herein to identify similar or analogous components or features; however, the use of the same reference number does not imply that the parts should be construed to be identical. Indeed, in many examples described herein, identically-numbered parts are distinct in structure or function.

Many of the details, dimensions, angles, or other portions shown in the Figures are merely illustrative of particular embodiments of the technology and may be schematically illustrated. As such, the schematic illustration of the features shown in the Figures is not intended to limit any structural features or configurations of the processing systems disclosed herein. Accordingly, other embodiments can have other details, dimensions, angles, or portions without departing from the spirit or scope of the present disclosure. In addition, further embodiments of the disclosure may be practiced without several of the details described below, while still other embodiments of the disclosure may be practiced with additional details or portions. Further, while various advantages associated with certain embodiments of the disclosure have been described above in the context of those embodiments, other embodiments may also exhibit such advantages, and not all embodiments need necessarily exhibit such advantages to fall within the scope of the disclosure.

I/We claim:

1. A method for processing one or more materials or compositions of materials with a laser processing system, the method comprising:
generating, via a first camera carried by the laser processing system, a first preview image of one or more materials to be processed, wherein the first preview image comprises an image of an entire material processing field;
generating, via a second camera carried by the laser processing system, a second preview image, wherein the second preview image comprises an image of only a selected portion of the material processing field from the first preview image; and
based on the second preview image, modifying a design file relative to a material to be processed.

2. The method of claim 1, further comprising directing a laser beam from a laser source toward the material to be processed after modifying the design file.

3. The method of claim 1 wherein the first camera is carried by a lid of a housing of the laser processing system.

4. The method of claim 3 wherein generating the first preview image with the first camera comprises obtaining image data from all or substantially all of a material processing field with the camera in a fixed position.

5. The method of claim 3 wherein generating the first preview image with the first camera comprises obtaining image data when the lid is in an open position relative to the housing of the laser processing system.

6. The method of claim 1 wherein the second camera is movably carried by an optical carriage assembly of the laser processing system.

7. The method of claim 1 wherein generating the second preview image with the second camera comprises obtaining image data from only a selected region of a material processing field that is less than the entire material processing field as the optical carriage assembly moves through the selected region.

8. The method of claim 1 wherein generating the second preview image with the second camera comprises obtaining a series of subviews stitched or otherwise joined together to form the second preview image, and wherein the second preview image is smaller in size than the entire material processing field.

9. The method of claim 1 wherein modifying the design file relative to the material comprises receiving user input regarding modifications to the design file prior to processing, and wherein the user input comprises translating, rotating, scaling, skewing, and/or otherwise manipulating the design file relative to the material prior to processing.

10. The method of claim 1 wherein modifying the design file relative to the material comprises automatically updating the design file prior to processing.

11. The method of claim 1 wherein generating the first preview image and/or generating the second preview image further comprises generating a virtual representation of how the material to be processed will appear when processing is complete.

12. A laser material processing system, comprising:
a housing with a material support therein;
a lid pivotably coupled to and movable relative to the housing;
an optical carriage assembly configured to receive and modify a laser beam from a laser source and direct the laser beam toward a material to be processed carried by the material support;
a display; and
a multi-camera vision subsystem operably coupled to a controller and the display, wherein the multi-camera vision subsystem comprises—
a first camera carried by the lid and configured to obtain first imaging data; and
a second camera carried by the optical carriage assembly and configured to provide second imaging data,
wherein the multi-camera vision subsystem is configured to display the first and second imaging data via the display.

13. The laser material processing system of claim 12 wherein the first imaging data from the first camera comprises imaging data from all or substantially all of a material processing field within the housing.

14. The laser material processing system of claim 12 wherein the first imaging data from the first camera comprises imaging data captured when the lid is in an open arrangement relative to the housing.

15. The laser material processing system of claim 12 wherein the first camera is configured to obtain the first imaging data when in a fixed state.

16. The laser material processing system of claim 12 wherein the second imaging data from the second camera comprises imaging data from only a selected region of the material processing field that is less than the entire material processing field.

17. The laser material processing system of claim 12 wherein the second camera is configured to obtain the second imaging data after being selectively relocated to selected regions of the material processing field along with the optical carriage assembly.

18. The laser material processing system of claim 12 wherein the optical carriage assembly of the beam delivery subsystem is adapted to be selectively positioned in an X- and Y-direction within a material processing field within the housing.

19. The laser material processing system of claim 12 wherein the display is configured to display an image or representation of the work plane and material being processed both before and during laser processing.

20. A method, comprising,
displaying a first preview of a material processing field within a laser material processing system and a material to be processed, wherein the first preview is based on first imaging data from a first camera of the laser material processing system, and wherein the first camera is a fixed/static overhead camera carried by a lid of the laser material processing system;
based on input from an operator, scanning the one or more areas of interest on the material to be processed with a second camera of the laser material processing system, wherein the second camera is a movable camera carried by the optical carriage assembly of the laser material processing system;
displaying a second preview of the material processing field and the material to be processed based on second imaging data from the second camera, wherein the second imaging data comprises one or more detailed subviews of the one or more areas of interest;
updating a design file associated with the material to be processed based, at least in part, on the second image data; and
directing a laser beam from a laser source toward the material to be processed based, at least in part, on instructions from the updated design file.
